(19) United States
(12) Patent Application Publication
(10) Pub. No.: US 2025/0174958 A1
(43) Pub. Date: May 29, 2025

(54) FEMTOSECOND FIBER LASER SYTEM

(71) Applicants: ELECTRONICS AND TELECOMMUNICATIONS RESEARCH INSTITUTE, Daejeon (KR); BlueTileLab, Inc, Daejeon (KR)

(72) Inventors: Hong-Seok SEO, Daejeon (KR); Hyung Woo KIM, Incheon (KR); Dong Hoon SONG, Daejeon (KR)

(21) Appl. No.: 18/938,410

(22) Filed: Nov. 6, 2024

(30) Foreign Application Priority Data
Nov. 28, 2023 (KR) 10-2023-0168264
Sep. 2, 2024 (KR) 10-2024-0118507

(51) Int. Cl. H01S 3/11; H01S 3/00; H01S 3/067; H01S 3/08

(52) U.S. Cl. CPC H01S 3/11; H01S 3/0057; H01S 3/06791; H01S 3/08054

(57) ABSTRACT

Provided is a femtosecond fiber laser system including a femtosecond light source configured to generate femtosecond laser light, a pulse picker connected to the femtosecond light source and configured to modulate the femtosecond laser light to generate pulsed laser light, a main amplifier connected to the pulse picker and configured to amplify the pulsed laser light, and a first continuous wave light source connected to the main amplifier and configured to provide first continuous wave laser light to the main amplifier.

### CROSS-REFERENCE TO RELATED APPLICATIONS

This U.S. non-provisional patent application claims priority under 35 U.S.C. § 119 of Korean Patent Application No. 10-2023-0168264, filed on Nov. 28, 2023, and No. 10-2024-0118507, field on Sep. 2, 2024, the entire contents of which are hereby incorporated by reference.

### BACKGROUND

### 1. Field of the Invention

The present disclosure herein relates to a laser system, and more particularly, to a femtosecond fiber laser system.

### 2. Description of Related Art

Femtosecond laser light may be used when cutting a semiconductor wafer and the electrodes of a secondary battery in an industrial site. The femtosecond laser light may control a repetition rate through a pulse control signal and also be modulated to laser light with femtosecond laser pulse trains. The pulsed laser light may reduce cut surface defects of the semiconductor wafer and the secondary battery electrodes. The pulsed laser light may be generated by a femtosecond fiber laser system. A typical femtosecond fiber laser system may use an optical shutter element in the end of the system to switch femtosecond laser light into femtosecond light in a pulse train type. However, the optical shutter element raises an issue of increasing the size of the system, increasing power consumption, and having a low switching speed.

### SUMMARY

The present disclosure provides a femtosecond fiber laser system capable of removing and omitting a shutter plate, and preventing damage to a main amplifier during an off time of pulsed laser light.

An embodiment of the inventive concept provides a femtosecond fiber laser system including: a femtosecond light source configured to generate femtosecond laser light; a pulse picker connected to the femtosecond light source and configured to modulate the femtosecond laser light to generate pulsed laser light; a main amplifier connected to the pulse picker and configured to amplify the pulsed laser light; and a first continuous wave light source connected to the main amplifier and configured to provide first continuous wave laser light to the main amplifier.

In an embodiment, the femtosecond fiber laser system may further include a preamplifier provided between the femtosecond light source and the pulse picker, and configured to amplify the femtosecond laser light.

In an embodiment, the femtosecond fiber laser system may further include a pulse width stretcher provided between the femtosecond light source and the preamplifier and configured to extend a pulse width of the femtosecond laser light.

In an embodiment, the femtosecond fiber laser system may further include a pulse width compressor connected to the main amplifier and configured to compress a pulse width of the pulsed laser light.

In an embodiment, the pulse width compressor may include: an output mirror configured to transmit the pulsed laser light and the first continuous wave laser light; a first grating provided adjacent to the output mirror and configured to diffract the pulsed laser light and the first continuous wave laser light; a second grating provided adjacent to the first grating and configured to diffract again the pulsed laser light and the first continuous wave laser light; and a mirror provided adjacent to the second grating and configured to reflect the pulsed laser light to the second grating.

In an embodiment, the pulse width compressor may further include a blocking plate disposed between the second grating and the mirror and provided in an edge of the pulsed laser light to block the first continuous wave laser light.

In an embodiment, the femtosecond fiber laser system may further include a polarization plate provided between the main amplifier and the pulse width compressor and configured to block the first continuous wave laser light.

In an embodiment, the femtosecond fiber laser system may further include a second continuous wave light source connected to the main amplifier and configured to provide second continuous wave laser light having a longer wavelength than the first continuous wave laser light.

In an embodiment, the first continuous wave light source may include: a first pump light source configured to generate first pump light; and a first ring resonator connected to the first pump light source and having a first radius.

In an embodiment, the second continuous wave light source may include: a second pump light source configured to generate second pump light; and a second ring resonator connected to the second pump light source and having a second radius larger than the first radius.

In an embodiment of the inventive concept, a femtosecond fiber laser system includes: a femtosecond light source configured to generate femtosecond laser light; a pulse width stretcher configured to extend a pulse width of the femtosecond laser light; a preamplifier configured to amplify the femtosecond laser light; a pulse picker configured to modulate the femtosecond laser light to generate pulsed laser light; a main amplifier configured to amplify the pulsed laser light; a first continuous wave light source configured to provide first continuous wave laser light different from the pulsed laser light to the main amplifier; and a second continuous wave light source configured to provide second continuous wave laser light having a longer wavelength than the first continuous wave laser light to the main amplifier.

In an embodiment, the first continuous wave light source may include: a first pump light source configured to generate first pump light; and a first ring resonator connected to the first pump light source and having a first radius.

In an embodiment, the second continuous wave light source may include: a second pump light source configured to generate second pump light; and a second ring resonator connected to the second pump light source and having a second radius larger than the first radius.

In an embodiment, the femtosecond fiber laser system may further include a pulse width compressor connected to the main amplifier and configured to compress a pulse width of the pulsed laser light.

In an embodiment, the pulse width compressor may further include: an output mirror configured to transmit the pulsed laser light and the first continuous wave laser light; a first grating provided adjacent to the output mirror and configured to diffract the pulsed laser light and the first continuous wave laser light; a second grating provided adjacent to the first grating and configured to diffract again the pulsed laser light and the first continuous wave laser light; a mirror provided adjacent to the second grating and configured to reflect the pulsed laser light to the second grating; and blocking plates disposed between the second grating and the mirror, and provided in edges of the pulsed laser light to block the first continuous wave laser light. The pulsed laser light may be diffracted again to the second grating to be transmitted and incident to the first grating in a state where the first continuous wave laser light is blocked, and the light transmitted through the first grating is incident to a machining device via the output mirror.

In an embodiment, each of the blocking plates may have an arc sector shape.

In an embodiment, the femtosecond fiber laser system may further include a polarization plate provided between the main amplifier and the pulse width compressor and configured to block the first continuous wave laser light and the second continuous wave laser light.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a block diagram showing an example of a femtosecond fiber laser system according to the inventive concept;

FIG. 2 shows an is a block diagram showing an application example of the femtosecond fiber laser system of FIG. 1;

FIG. 3 is graphs showing examples of a pulse control signal, femtosecond laser light having laser pulse trains and continuous wave laser light of a picker control unit of FIG. 2;

FIGS. 4 and 5 are graphs respectively showing wavelength band examples of the pulsed laser light and the continuous wave laser light of FIG. 2;

FIGS. 6 and 7 show examples of a pulse width compressor of FIG. 2;

FIGS. 8 and 9 show examples of a femtosecond fiber laser system according to the inventive concept;

FIGS. 10 and 11 show examples of a femtosecond fiber laser system according to the inventive concept;

FIG. 12 is a graph showing an example of pulsed laser light, first continuous wave laser light, and second continuous wave laser light of FIG. 11;

FIG. 13 illustrates an example of the pulse width compressor of FIG. 11; and

FIG. 14 is a plan view showing an example of a blocking plate of FIG. 13.

### DETAILED DESCRIPTION

Hereinafter, exemplary embodiments of the present disclosure will be described in conjunction with the accompanying drawings. The above and other aspects, features, and advantages of the present disclosure will become apparent from the detailed description of the following embodiments in conjunction with the accompanying drawings. However, it should be understood that the present invention is not limited to the following embodiments and may be embodied in different ways. Rather, the embodiments are provided so that so that this disclosure will be thorough and complete and will fully convey the concept of the invention to those skilled in the art, and the present disclosure will only be defined by the appended claims. Throughout this specification, like numerals refer to like elements.

The terminology used herein is for the purpose of describing particular embodiments only and is not intended to limit the scope of the present disclosure. As used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof. Also, as just exemplary embodiments, reference numerals shown according to an order of description are not limited to the order.

Moreover, exemplary embodiments will be described herein with reference to cross-sectional views and/or plane views that are idealized exemplary illustrations. In the drawings, the thickness of layers and regions are exaggerated for effective description of the technical details. Accordingly, variations from the shapes of the illustrations as a result, for example, of manufacturing techniques and/or tolerances, are to be expected. Thus, exemplary embodiments should not be construed as limited to specific shapes illustrated herein but are to include deviations in shapes that result from manufacturing.

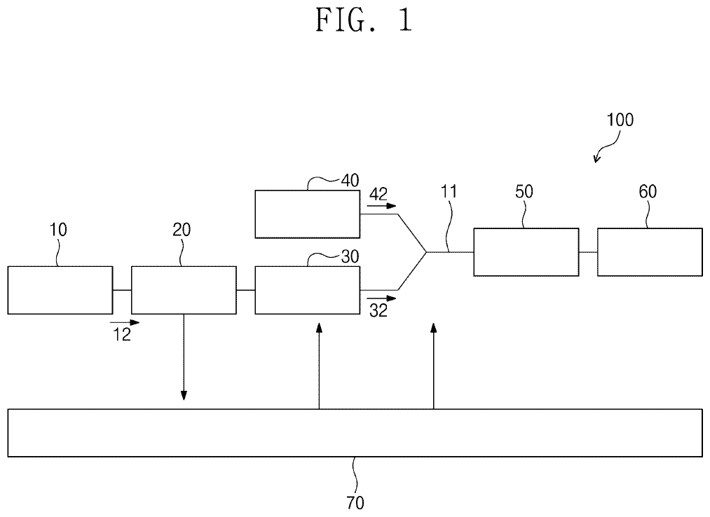

FIG. 1 shows an example of a femtosecond fiber laser system 100 according to the inventive concept.

Referring to FIG. 1, the femtosecond fiber laser system 100 may include a femtosecond light source 10, a preamplifier 20, a pulse picker 30, a continuous wave light source 40, a main amplifier 50, a pulse width compressor 60, and a controller 70.

The femtosecond light source 10 may generate femtosecond laser light 12. The femtosecond laser light 12 may have a frequency from about 10 MHz to about 1000 MHz.

The preamplifier 20 may be connected to the femtosecond light source 10. The preamplifier 20 may amplify the femtosecond laser light 12.

The pulse picker 30 may be connected to the preamplifier 20. The pulse picker 30 may modulate the femtosecond laser light 12 to generate pulsed laser light 32. Here, the pulsed laser light 32 means femtosecond laser light with arbitrary pulse trains.

The first continuous wave light source 40 may be connected to the pulse picker 30 and the main amplifier 50 through an optical fiber 11. The first continuous wave light source 40 may provide the first continuous wave laser light 42 to the main amplifier 50. For example, the first continuous wave light source 40 may include a laser diode, but is not limited thereto.

The main amplifier 50 may be provided between the pulse picker 30 and the pulse width compressor 60. The main amplifier 50 may be provided between the first continuous wave light source 40 and the pulse width compressor 60. The main amplifier 50 may amplify the pulsed laser light 32. The main amplifier 50 may amplify the first continuous wave laser light 42.

The pulse width compressor 60 may be connected to the main amplifier 50. The pulse width compressor 60 may compress the pulse width of the pulsed laser light 32.

The controller 70 may control the preamplifier 20, the pulse picker 30, and the main amplifier 50. The controller 70 may control the preamplifier 20 and the pulse picker 30 to control generation of the femtosecond laser light 12 and the pulsed laser light 32. When the femtosecond laser light 12 and the pulsed laser light 32 are not generated by the control of the controller 70, the first continuous wave light source 40 may provide the first continuous wave laser light 42 to the main amplifier 50 to prevent burning of and damage to the main amplifier 50.

Therefore, the femtosecond fiber laser system 100 of the inventive concept may use the first continuous light source 40 configured to provide the first continuous wave laser light 42 to the main amplifier 50 to remove and skip a typical optical shutter element configured to switch the pulsed laser light 32 in the end of the laser system 100, and prevent damage to the main amplifier 50 due to turn-on of the first continuous wave light source 40 during an off time in which the pulsed laser light 32 is off by the controller.

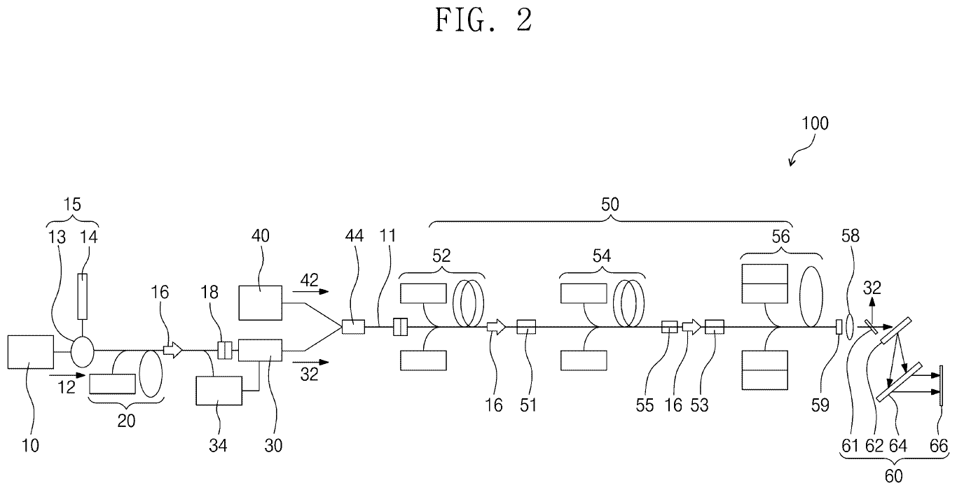

FIG. 2 shows an application example of the femtosecond fiber laser system 100 of FIG. 1.

Referring to FIG. 2, the femtosecond fiber laser system 100 of the inventive concept may further include a pulse width stretcher 15, a picker controller 34, and a coupler 44.

The pulse width stretcher 15 may be provided between the femtosecond light source 10 and the preamplifier 20. The pulse width stretcher 15 may extend the pulse width of the femtosecond laser light 12. According to an example, the pulse width stretcher 15 may include a circulator 13 and a chirped fiber Bragg grating 14. The circulator 13 may be provided between the femtosecond light source 10 and the preamplifier 20. Although not shown, the circulator 13 may include at least one port. The chirped fiber Bragg grating 14 may be connected to the port of the circulator 13. The chirped fiber Bragg grating 14 may extend the pulse width of the femtosecond laser light 12.

An isolator 16 may be provided in the optical fiber 11 between the preamplifier 20 and the pulse picker 30. The isolator 16 may prevent return of the femtosecond laser light 12 to protect the preamplifier 20 and the femtosecond light source 10. An optical fiber between the preamplifier 20 and the isolator 16 may include an Yb-doped polarization-maintaining fiber as a gain medium optical fiber. The preamplifier 20 may include a laser diode.

The picker controller 34 may be connected to the pulse picker 30. The picker controller 34 may control a pulse repetition rate and the pulse trains. A fiber-to-fiber coupler 18 may be provided in the optical fiber 11 adjacent to the picker controller 34.

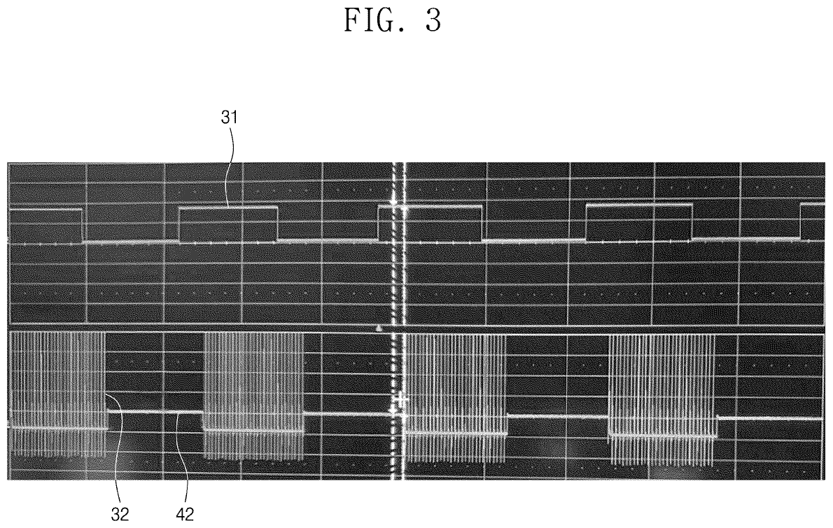

FIG. 3 shows examples of a pulse control signal 31 from the picker controller 34, the pulse laser light 32, and the first continuous wave laser light 42 of FIG. 2.

Referring to FIG. 3, the picker controller 34 may provide the pulse control signal 31 to the pulse picker 30 and the pulse picker 30 may modulate the femtosecond laser light 12 on the basis of the pulse control signal 31 to generate the pulsed laser light 32. The pulse control signal 31 and the pulsed laser light may respectively have frequencies from about 0 Hz to about 10 MHz.

Referring to FIG. 2 again, a coupler 44 may be provided between the pulse picker 30 and the main amplifier 50. The coupler 44 may be provided between the first continuous wave light source 40 and the main amplifier 50. Namely, the coupler 44 may connect the pulse picker 30 and the first continuous wave light source 40 to the main amplifier 50. For example, the coupler 44 may include a Y-branch coupler. The coupler 44 may couple optical fibers 11 connected to the first continuous wave light source 40 and the pulse picker 30. The optical fibers 11 may include single-mode optical fibers. Alternatively, the optical fibers 11 may include multi-mode optical fibers, but are not limited thereto.

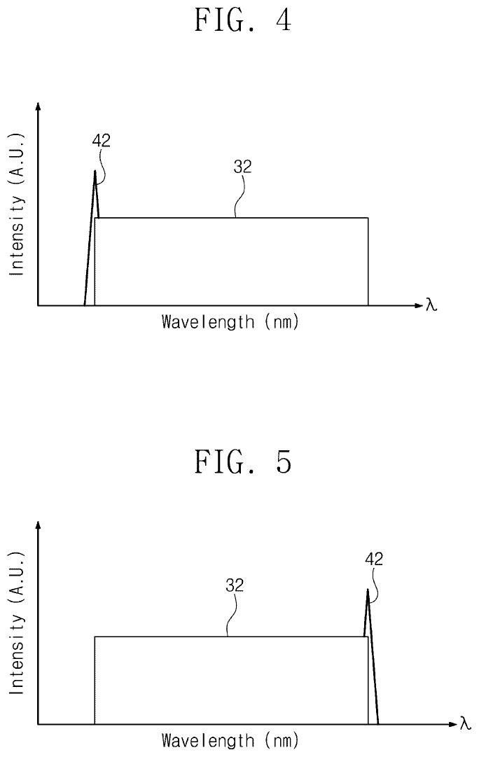

FIGS. 4 and 5 respectively show example wavelength bands of the pulsed laser light 32 and the continuous wave laser light 42 of FIG. 2.

Referring to FIGS. 4 and 5, a wavelength peak of the first continuous wave laser light 42 may overlap with or abut on any one of both ends of the wavelength band of the pulsed laser light 32, or may be or may not be overlapped but should be present within a wavelength band of a filter in the amplifier.

Referring to FIGS. 2 and 3, the main amplifier 50 may amplify the pulsed laser light 32 and the first continuous wave laser light 42. For example, the main amplifier 50 may include a plurality of laser diodes. According to an example, the main amplifier 50 may include a first main amplifier 52, a second main amplifier 54, and a third main amplifier 56.

The first main amplifier 52 may be connected between the coupler 44 and the second main amplifier 54. For example, the first main amplifier 52 may include a laser diode and a gain medium optical fiber. The gain medium optical fiber of the first main amplifier 52 may include an Yb-doped polarization-maintaining fiber. A first filter 51 may be connected between the first main amplifier 52 and the second main amplifier 54 through an optical fiber. The first filter 51 may remove noise of the pulsed laser light 32, the noise being amplified by the first main amplifier 52. The isolator 16 may be provided between the first filter 51 and the gain medium optical fiber. The isolator 16 may block the reverse flows of the pulsed laser light 32 and the first continuous wave laser light 42 to increase the amplification efficiency of the first main amplifier 52.

The second main amplifier 54 may be connected between the first main amplifier 52 and the third main amplifier 56 through an optical fiber. For example, the second main amplifier 54 may include a laser diode and a gain medium optical fiber. The gain medium optical fiber of the second main amplifier 52 may include an Yb-doped polarization-maintaining fiber. A second filter 53 may be connected between the second main amplifier 54 and the third main amplifier 56 through an optical fiber. The second filter 53 may remove noise of the pulsed laser light 32, the noise being amplified by the second main amplifier 54. A first cladding mode stripper 55 may be provided between the gain medium optical fiber of the second main amplifier 54 and the second filter 53. The first cladding mode stripper 55 may remove a residual pump in the cladding of the gain medium optical fiber. The isolator 16 may be provided between the first cladding mode stripper 55 and the second filter 53. The isolator 16 may block the reverse flows of the pulsed laser light 32 and the first continuous wave laser light 42 to increase the amplification efficiency of the second main amplifier 54.

The third main amplifier 56 may be connected between the second main amplifier 54 and the pulse width compressor 60 through an optical fiber. For example, the third main amplifier 56 may include a laser diode and a gain medium optical fiber. The gain medium optical fiber between the third main amplifier 56 and a lens 58 may include an Yb-doped polarization-maintaining fiber. An end cap 59 may be provided in the end of the gain medium optical fiber. The end cap 50 may reduce damage to the end of the optical fiber, the damage being caused by the amplified pulsed laser light 32 and the first continuous wave laser light 42. The lens 58 may be provided between the third main amplifier 56 and the pulse width compressor 60. The lens 58 may collimate the pulsed laser light 32 and the first continuous wave laser light 42 on the pulse width compressor 60.

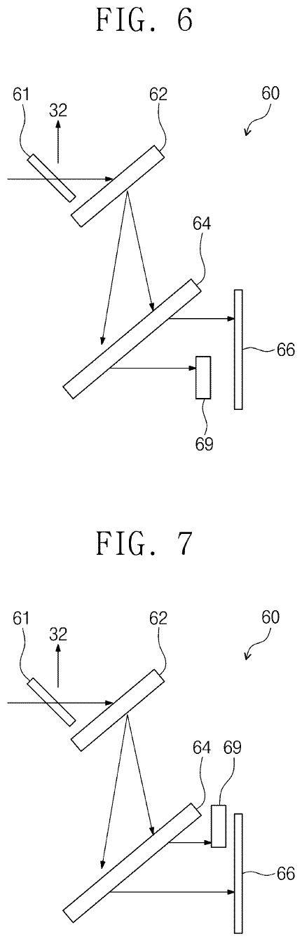

FIGS. 6 and 7 show examples of the pulse width compressor of FIG. 2.

Referring to FIGS. 2, 6 and 7, the pulse width compressor 60 may include an output mirror 61, a first grating 62, a second grating 64, a mirror 66, and a blocking plate 69.

The output mirror 61 may be provided between the third main amplifier 56 and the first grating 62. The output mirror 61 may be under the paths of the pulsed laser light 32 and the first continuous wave laser light 42. Accordingly, the pulsed laser light 32 and the first continuous wave laser light 42 may be directly transmitted through the first grating 62 regardless of the output mirror 61.

The first grating 62 may be provided between the output mirror 61 and the second grating 64. The first grating 62 may diffract the pulsed laser light 32 and the first continuous wave laser light 42. The pulsed laser light 32 and the first continuous wave laser light 42 may be provided to the second grating 64.

The second grating 64 may be provided adjacent to the first grating 62. The second grating 64 may diffract the pulsed laser light 32 and the first continuous wave laser light 42 to provide the diffracted light beams to the mirror 66.

The mirror 66 may reflect the pulsed laser light 32 downward to the second grating 64. The pulsed laser light 32 reflected downward may be sequentially provided to the second grating 64, the first grating 62, and the output mirror 61. The pulsed laser light 32 may be reflected by the output mirror 61 to be output outside.

The blocking plate 69 may be provided between the mirror 66 and the second grating 64. The blocking plate 69 may block one edge of the pulsed laser light 32. Especially, the blocking plate 69 may block and remove the first continuous wave laser light 42 of the edge of the pulsed laser light 32.

Accordingly, the femtosecond fiber laser system 100 of the inventive concept may use the blocking plate 69 to remove the first continuous wave laser light 42 and output the pulsed laser light 32.

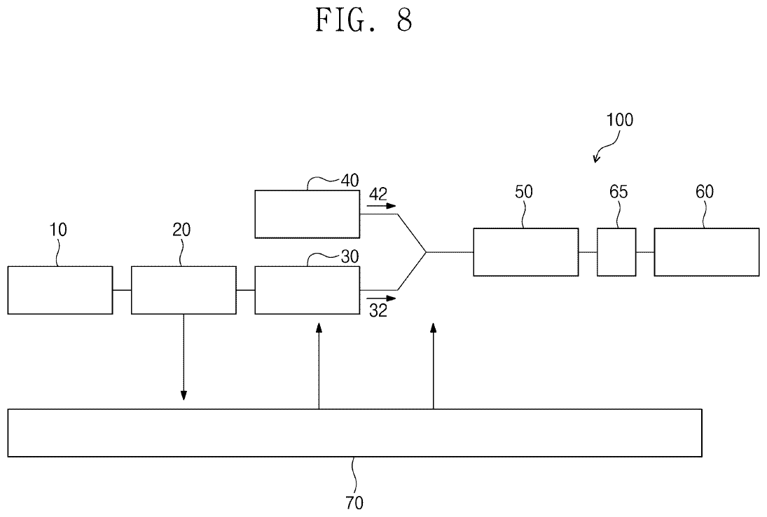

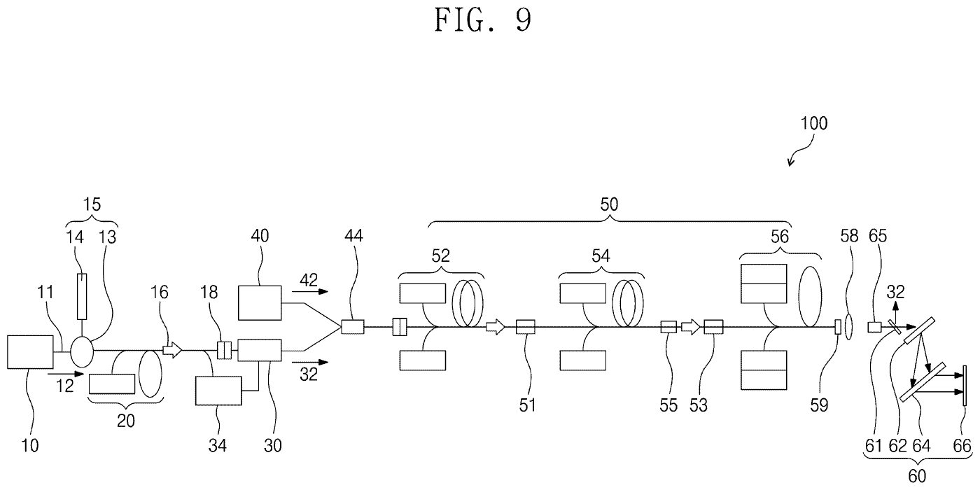

FIGS. 8 and 9 show examples of the femtosecond fiber laser system 100 according to the inventive concept.

Referring to FIGS. 8 and 9, the femtosecond fiber laser system 100 according to the inventive concept may further include a polarization plate 65. The polarization plate 65 may be provided between the main amplifier 50 and the pulse width compressor 60. The first continuous wave light source 40 provided perpendicular to a polarization axis of the pulsed laser light 32 may generate the first continuous wave laser light 42 polarized in one direction and the polarization plate 65 may remove the first continuous wave laser light 42. The polarization plate 65 may replace the blocking plate 69 of the pulse width compressor 60 of FIGS. 6 and 7. Specifically, the polarization plate 65 may have a polarizer perpendicular to the polarization direction of the first continuous wave laser light 42. Accordingly, the pulsed laser light 32 is transmitted without loss through the polarization plate 65. When the first continuous wave laser light 42 is polarized in a vertical direction, the polarization plate 65 may have a horizontal polarizer. When the first continuous wave laser light 42 is polarized in a horizontal direction, the polarization plate 65 may have a vertical polarizer. When the first continuous wave laser light 42 is right-circularly polarized, the polarization plate 65 may have a left-circular polarizer. When the first continuous wave laser light 42 is left-circularly polarized, the polarization plate 65 may have a right-circular polarizer.

The femtosecond light source 10, the pulse width stretcher 15, the preamplifier 20, the pulse picker 30, the first continuous wave light source 40, the main amplifier 50, and the pulse width compressor 60, and the controller 70 may be configured in the same way as FIGS. 1 and 2.

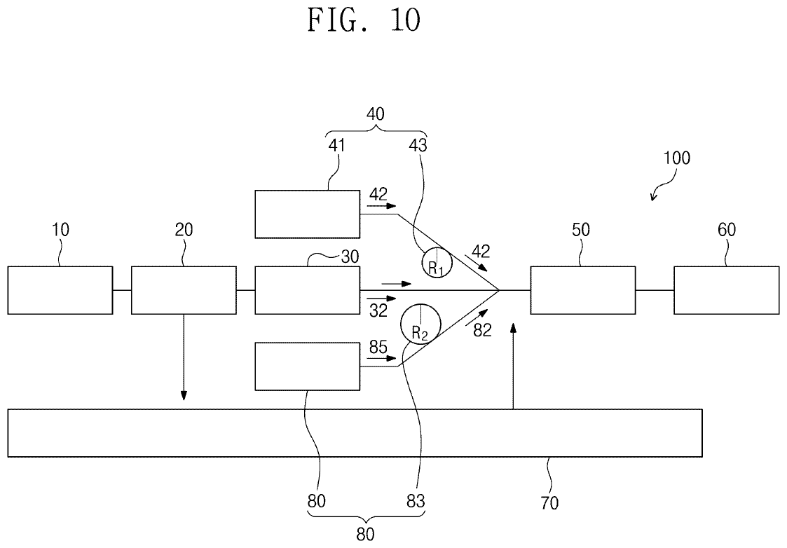

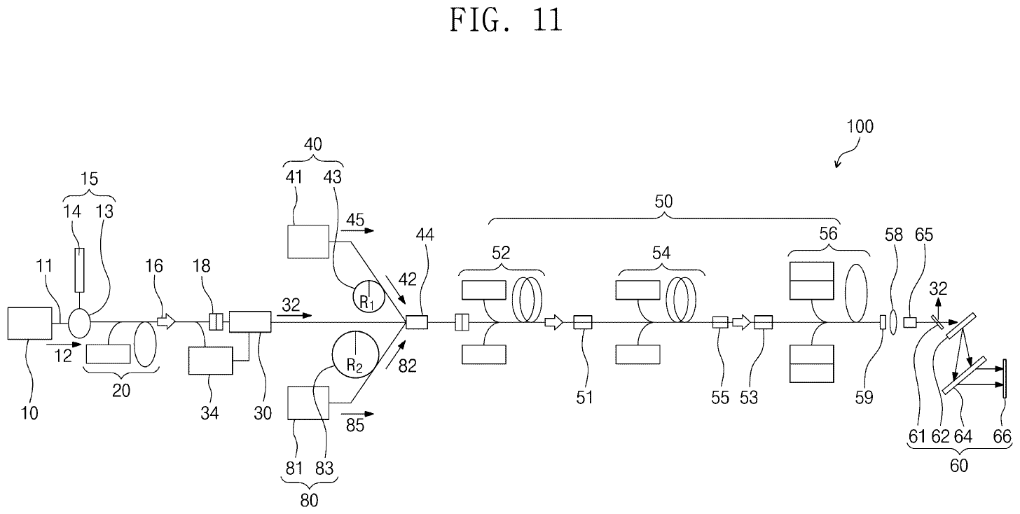

FIGS. 10 and 11 show examples of the femtosecond fiber laser system 100 according to the inventive concept.

Referring to FIGS. 10 and 11, the femtosecond fiber laser system 100 according to the inventive concept may further include a second continuous wave light source 80 configured to generate second continuous wave light 82 having a longer wavelength than the first continuous wave light 42 of the first continuous wave light source 40.

The first continuous wave light source 40 may include a first pump light source 41 and a first ring resonator 43. The first pump light source 41 may generate first pump light 45. The first pump light source 41 may include a laser diode. The first ring resonator 43 may be provided between the first pump light source 41 and the coupler 44. The first ring resonator 43 may have a first radius R1. The first ring resonator 43 may resonate the first pump light 45 to generate the first continuous wave laser light 42.

The second continuous wave light source 80 may be connected to the coupler 44. The second continuous wave light source 80 may include a second pump light source 81 and a second ring resonator 83. The second pump light source 81 may be the same as the first pump light source 41. The second pump light source 81 may generate second pump light 85. The second pump light source 81 may include a laser diode. The second ring resonator 83 may be provided between the second pump light source 81 and the coupler 44. The second ring resonator 83 may have a second radius R2. The second radius R2 may be larger than the first radius R1. The second ring resonator 83 may resonate the second pump light 85 to generate the second continuous wave laser light 82.

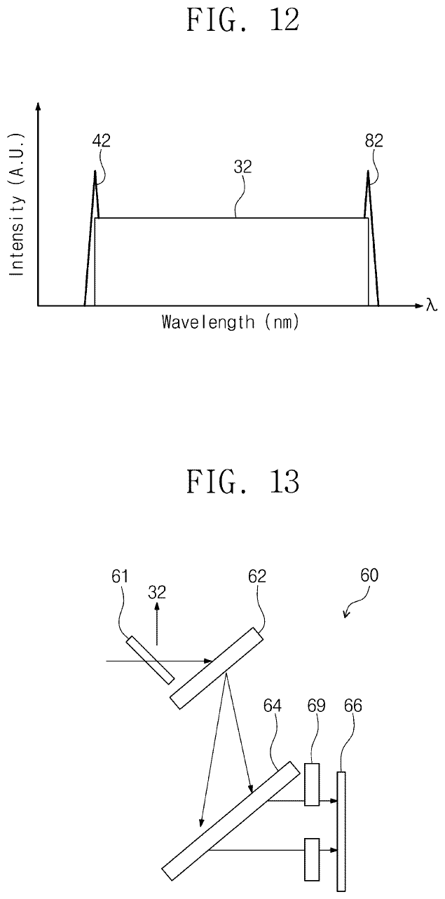

FIG. 12 shows examples of the pulsed laser light 32, the first continuous wave laser light 42, and the second continuous wave laser light 82 of FIG. 11.

Referring to FIG. 12, a wavelength peak of the first continuous wave laser light 42 may overlap one side of the wavelength band of the pulsed laser light 32, and a wavelength peak of the second continuous wave laser light 82 may overlap the other side of the wavelength band of the pulsed laser light 32. The wavelength peak of the first continuous wave laser light 42 may overlap a short wavelength of the pulsed laser light 32, and the wavelength peak of the second continuous wave laser light 82 may overlap a long wavelength of the pulsed laser light 32.

Referring to FIG. 11, the main amplifier 50 may amplify the pulsed laser light 32, the first continuous wave laser light 42, and the second continuous wave laser light 82. The first continuous wave laser light 42 and the second continuous wave laser light 82 may prevent damage to the main amplifier 50 during the off time of the pulsed laser light 32. At the instance when the pulsed laser light 32 is off, the first pump light source 40 and the second pump light source 80 are turned on and the first continuous wave laser light 42 and the second continuous wave laser light 82 may be emitted and input to the main amplifier 50, thereby preventing damage to the main amplifier 50.

The first continuous wave laser light 42 and the second continuous wave laser light 82 may have the same polarization. In addition, the pulsed laser light 32 may have vertical polarization to the first continuous wave laser light 42 and the second continuous wave laser light 82.

The polarization plate 65 configured to remove the first continuous wave laser light 42 and the second continuous wave laser light 82 may be included between the main amplifier 50 and the pulse width compressor 60. The polarization plate 65 may have a polarizer perpendicular to a polarization direction of the first continuous wave laser light 42 and the second continuous wave laser light 82. When the first continuous wave laser light 42 and the second continuous wave laser light 82 are horizontally polarized, the polarization plate 65 may have a vertical polarizer. When the first continuous wave laser light 42 and the second continuous wave laser light 82 are right-circularly polarized, the polarization plate 65 may have a left-circular polarizer.

The pulse width compressor 60 may compress the pulse width of the pulsed laser light 32 and block or remove the first continuous wave laser light 42 and the second continuous wave laser light 82.

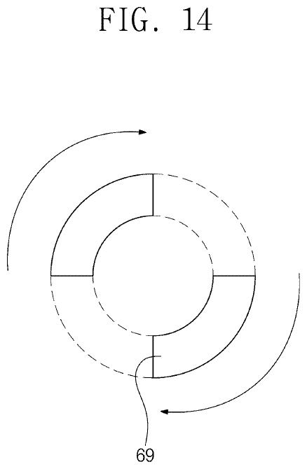

FIG. 13 shows an example of the pulse width compressor 60 of FIG. 11.

Referring to FIG. 13, blocking plates 69 of the pulse width compressor 60 may be provided at both edges of the mirror 66. The blocking plates 69 may block both edges of the pulsed laser light 32 to remove the first continuous wave laser light 42 and the second continuous wave laser light 82. The blocking plates 69 may replace the polarization plate 65 of FIG. 11. The mirror 66 may reflect the pulsed laser light 32 to the second grating 54 and the second grating 64 may transmit the pulsed laser light 32 through the first grating 62. The output mirror 61 may reflect the pulsed laser light 32 to the outside.

FIG. 14 shows an example of the blocking plates 69 of FIG. 13.

Referring to FIG. 14, the blocking plates 69 may have a fan shape and rotate in their azimuthal direction. For example, each of the blocking plates 69 may have an arc sector shape. The blocking plate may completely block the first continuous wave laser light 42 and the second continuous wave laser light 82 according to the rotation direction and partially transmit to output them to the outside.

As described above, the femtosecond fiber laser system according to an embodiment of the inventive concept may use the first continuous wave light source configured to provide the first continuous wave light to the main amplifier to remove and omit an optical shutter element, and prevent damage to the main amplifier during an off time of the pulsed laser light.

The exemplary embodiments of the present disclosure have been described above with reference to the accompanying drawings, but those skilled in the art will understand that the present disclosure may be implemented in another concrete form without changing the technical spirit or an essential feature thereof. Therefore, the aforementioned exemplary embodiments are all illustrative and are not restricted to a limited form.

What is claimed is:

1. A femtosecond fiber laser system comprising:
a femtosecond light source configured to generate femtosecond laser light;
a pulse picker connected to the femtosecond light source and configured to modulate the femtosecond laser light to generate pulsed laser light;
a main amplifier connected to the pulse picker and configured to amplify the pulsed laser light; and
a first continuous wave light source connected to the main amplifier and configured to provide first continuous wave laser light to the main amplifier.

2. The femtosecond fiber laser system according to claim 1, further comprising:
a preamplifier provided between the femtosecond light source and the pulse picker, and configured to amplify the femtosecond laser light.

3. The femtosecond fiber laser system according to claim 2, further comprising:
a pulse width stretcher provided between the femtosecond light source and the preamplifier and configured to extend a pulse width of the femtosecond laser light.

4. The femtosecond fiber laser system according to claim 1, further comprising:
a pulse width compressor connected to the main amplifier and configured to compress a pulse width of the pulsed laser light.

5. The femtosecond fiber laser system according to claim 4, wherein the pulse width compressor comprises:
an output mirror configured to transmit the pulsed laser light and the first continuous wave laser light;
a first grating provided adjacent to the output mirror and configured to diffract the pulsed laser light and the first continuous wave laser light;
a second grating provided adjacent to the first grating and configured to diffract again the pulsed laser light and the first continuous wave laser light; and
a mirror provided adjacent to the second grating and configured to reflect the pulsed laser light to the second grating.

6. The femtosecond fiber laser system according to claim 5, wherein the pulse width compressor further comprises a blocking plate disposed between the second grating and the mirror, and provided in an edge of the pulsed laser light to block the first continuous wave laser light.

7. The femtosecond fiber laser system according to claim 4, further comprising:
a polarization plate provided between the main amplifier and the pulse width compressor and configured to block the first continuous wave laser light.

8. The femtosecond fiber laser system according to claim 1, further comprising:
a second continuous wave light source connected to the main amplifier and configured to provide second continuous wave laser light having a longer wavelength than the first continuous wave laser light.

9. The femtosecond fiber laser system according to claim 8, wherein the first continuous wave light source comprises:
a first pump light source configured to generate first pump light; and
a first ring resonator connected to the first pump light source and having a first radius.

10. The femtosecond fiber laser system according to claim 9, wherein the second continuous wave light source comprises:
a second pump light source configured to generate second pump light; and
a second ring resonator connected to the second pump light source and having a second radius larger than the first radius.

11. A femtosecond fiber laser system comprising:
a femtosecond light source configured to generate femtosecond laser light;
a pulse width stretcher configured to extend a pulse width of the femtosecond laser light;
a preamplifier configured to amplify the femtosecond laser light;
a pulse picker configured to modulate the femtosecond laser light to generate pulsed laser light;
a main amplifier configured to amplify the pulsed laser light;
a first continuous wave light source configured to provide first continuous wave laser light different from the pulsed laser light to the main amplifier; and
a second continuous wave light source configured to provide second continuous wave laser light having a longer wavelength than the first continuous wave laser light to the main amplifier.

12. The femtosecond fiber laser system according to claim 11, wherein the first continuous wave light source comprises:
a first pump light source configured to generate first pump light; and
a first ring resonator connected to the first pump light source and having a first radius.

13. The femtosecond fiber laser system according to claim 12, wherein the second continuous wave light source comprises:
a second pump light source configured to generate second pump light; and
a second ring resonator connected to the second pump light source and having a second radius larger than the first radius.

14. The femtosecond fiber laser system according to claim 11, further comprising:
a pulse width compressor connected to the main amplifier and configured to compress a pulse width of the pulsed laser light.

15. The femtosecond fiber laser system according to claim 14, wherein the pulse width compressor further comprises:
an output mirror configured to transmit the pulsed laser light and the first continuous wave laser light;
a first grating provided adjacent to the output mirror and configured to diffract the pulsed laser light and the first continuous wave laser light;
a second grating provided adjacent to the first grating and configured to diffract again the pulsed laser light and the first continuous wave laser light; and
a mirror provided adjacent to the second grating and configured to reflect the pulsed laser light to the second grating; and
blocking plates disposed between the second grating and the mirror. and provided in edges of the pulsed laser light to block the first continuous wave laser light.

16. The femtosecond fiber laser system according to claim 15, wherein each of the blocking plates has an arc sector shape.

17. The femtosecond fiber laser system according to claim 14, further comprising:
a polarization plate provided between the main amplifier and the pulse width compressor and configured to block the first continuous wave laser light and the second continuous wave laser light.
